(19) United States
(12) Patent Application Publication
(10) Pub. No.: US 2004/0103802 A1
(43) Pub. Date: Jun. 3, 2004

(54) PRINTERS COMPRISING A DRIVE ASSEMBLY AND A COUPLING

(76) Inventors: Manfred Herrmann Liebler, Erlenbach (DE); Bernd Kurt Masuch, Kurnach (DE); Kurt Johannes Weschenfelder, Zell/Main (DE)

Correspondence Address: Douglas R Hanscom, Jones Tullar & Cooper, Eads Station, Post Office Box 2266, Arlington, VA, 22202, US

(21) Appl. No.: 10/363,691

(22) PCT Filed: Sep. 17, 2001
(86) PCT No.: PCT/DE01/03558

(30) Foreign Application Priority Data
Sep. 20, 2000 (DE) 100 46 376.2

(51) Int. Cl. B41F 9/00

(52) U.S. Cl. 101/142

(57) ABSTRACT

A printer includes a cylinder pair that consists of a forme cylinder and a transfer cylinder. A satellite or steel cylinder forms a print position as it cooperates with the transfer cylinder of the cylinder pair. The forme cylinder and the transfer cylinder are a fixed coupling drive assembly which is driven by a common drive motor. The drive assembly of the cylinder pair and a drive system for the satellite or steel cylinder can be selectively mechanically coupled with each other by use of a coupling.

The invention relates to a printing unit in accordance with the preambles of claims 1, 22, 25, 26 and 27.

A printing press is known from EP 0 644 048 B1, wherein pairs of cylinders, each consisting of a forme and transfer cylinder, are mechanically fixedly coupled, and wherein each pair has its own drive motor. The pairs themselves cannot be coupled to each other.

DE 44 30 693 A1 discloses printing units of a printing press with separate configurations of cylinders which are driven individually or in groups. Cylinders, or groups of cylinders are not in a driven connection with each other.

A four-cylinder printing unit is known from DE 196 03 663 A1, wherein the two transfer cylinders which cooperate with each other are fixedly coupled to each other and can be selectively driven by the drive mechanism of one or both associated forme cylinders. In one embodiment, a pair of cylinders consisting of a forme and transfer cylinder, which can be driven at the forme cylinder, can be placed against this four-cylinder printing unit, and can be coupled into the drive assembly between the two first mentioned transfer cylinders for synchronization, or correctly registered printing.

The object of the invention is based on creating a printing unit.

In accordance with the invention, this object is attained by means of the characteristics of claims 1, 22, 25, 26 and 27.

The advantages which can be gained by means of the invention lie in particular in that a great operational diversity and variability of a printing unit or compound cylinders, along with a high degree of operational dependability, is provided by redundancy, without each cylinder being provided with its own drive mechanism. The invention combines the advantages of great flexibility of the expensive and elaborate single drive technology with the advantages of coupled cylinder groups, namely the savings of motors and the mechanical synchronization of the connected cylinders.

As a rule, by means of the advantageous arrangement of switchable couplings and motors, as many of the desired operating modes are possible as with the embodiment where all cylinders are provided with separate motors. Thus, with the coupling released it is possible to move cylinders, or groups of cylinders, independently of each other, which is required, for example, when the printing formes or rubber blankets are exchanged, when a paper web is drawn in, when rollers and cylinders are independently inked or washed. In many cases an auxiliary drive mechanism can therefore be omitted, since this can be taken over by the main drive mechanisms if the couplings are appropriately switched. In the same way is it possible to perform the switching of individual cylinders or cylinder groups of connected larger cylinders, in that new drive assemblies are formed by releasing couplings and activating other couplings.

Moreover, a substantial advantage lies in the option of standardizing individual small groups, which meet the above mentioned requirements, for example a pair of cylinders consisting of a forme cylinder and a transfer cylinder with an appropriate coupling, and of combining them in any desired way, depending on the request made in the purchase order, into larger units. An above mentioned pair with a coupling can also represent a standard group together with a counter-pressure or satellite cylinder. The journals of the cylinders can be embodied as needed, for example selectively with or without coupling, with a gear wheel which is fixed against relative rotation or can be fixed in place, matching a first or second drive level.

In particular in connection with printing units which can be switched from rubber-on-rubber to rubber-on steel operation, i.e. at least one of the transfer cylinders can be selectively placed against a satellite cylinder or a second transfer cylinder, a reversal of the direction of rotation of one or several cylinders is necessary, depending on the unit. With a five-cylinder printing unit an embodiment with one drive motor per pair of forme and transfer cylinders is advantageous, wherein the satellite cylinder can be coupled with one of the two or both drive motors, or pairs, depending on the paper guidance and mode of operation. For a seven-cylinder y- or lambda unit, which can be flexibly employed, for example, for the 3/0, 2/1 production run, the flying plate change, or during the imprint function in the course of 1/1 printing, an embodiment with only a total of two drive motors is sufficient for all requirements. Moreover, a 1/0 and a 1/1 production run is possible during two-web operations.

The invention can also be employed particularly advantageously and efficiently in nine-cylinder or ten-cylinder printing units, when maximum flexibility along with a minimal number of motors is required in view of the modes of operation to be met.

A minimum requirement, the independent fitting in pairs of the pairs of cylinders when a web has been drawn in, is realized with minimum outlay in an advantageous embodiment, wherein one or several pairs form a fixed drive assembly, and the satellite cylinder, which is embodied without its own drive motor, can be selectively coupled in or released.

The embodiment of each cooperating and fixedly coupled pair with a drive motor is advantageous here, wherein at least two of these pairs can be coupled with the satellite by means of a switchable connector. With the savings of two connectors, the embodiment with only two pairs switchably coupled to the satellite cylinder is advantageous in nine- or ten-cylinder printing units. In this way the satellite can be driven by the respectively other coupleable pair during partial reversal or stopping of a pair.

The selective coupling of a fixed drive assembly of the cylinder pair with a counter-pressure cylinder is the basis of the mentioned great variety of operating modes.

The great operational dependability because of the redundancy in the number of usable drive motors is also advantageous in the case of several drive mechanisms which can by connected by means of connectors.

Exemplary embodiments of the invention are represented in the drawings and will be described in greater detail in what follows.

Shown are in:

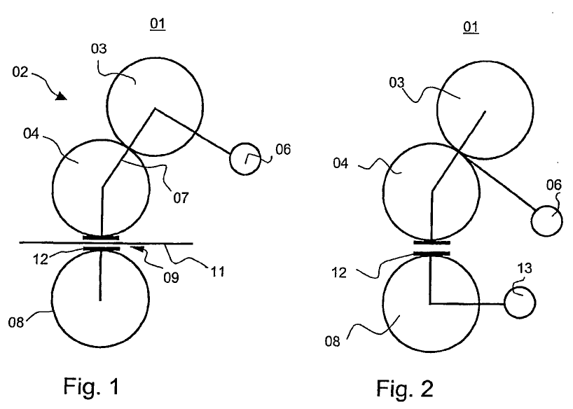

FIG. 1, a schematic representation of a lateral view of a first exemplary embodiment of a printing unit,

FIG. 2, a schematic representation of a lateral view of a second exemplary embodiment of a printing unit,

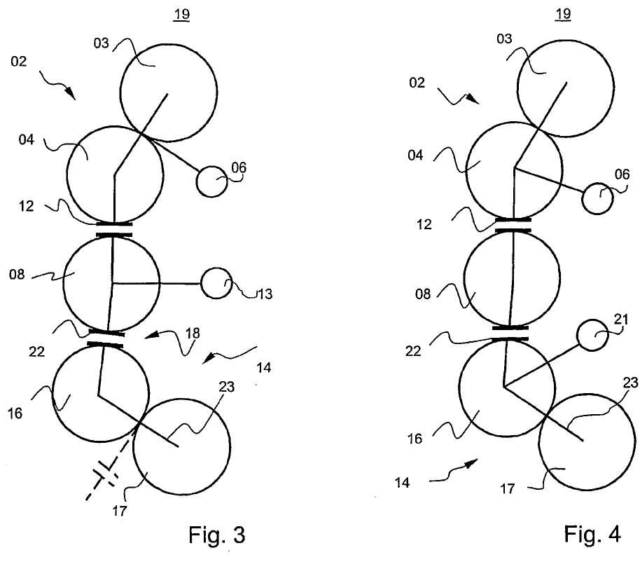

FIG. 3, a schematic representation of a lateral view of a third exemplary embodiment of a printing unit as five-cylinder printing unit,

FIG. 4, a schematic representation of a lateral view of a fourth exemplary embodiment of a printing unit as five-cylinder printing unit,

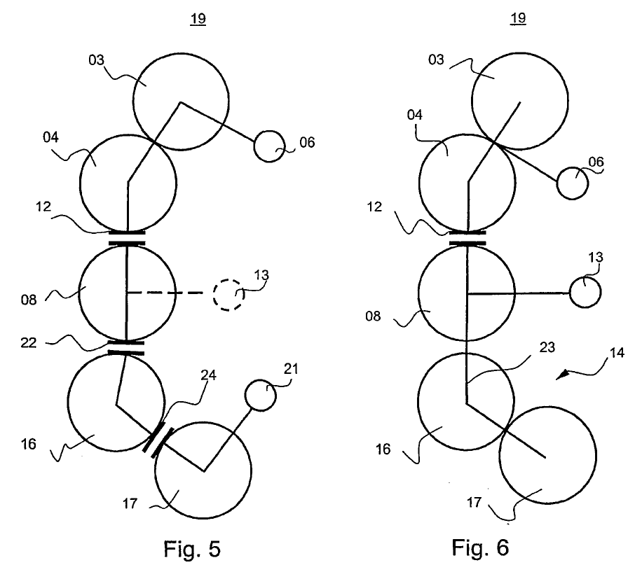

FIG. 5, a schematic representation of a lateral view of a fifth exemplary embodiment of a printing unit as five-cylinder printing unit,

FIG. 6, a schematic representation of a lateral view of a sixth exemplary embodiment of a printing unit as five-cylinder printing unit,

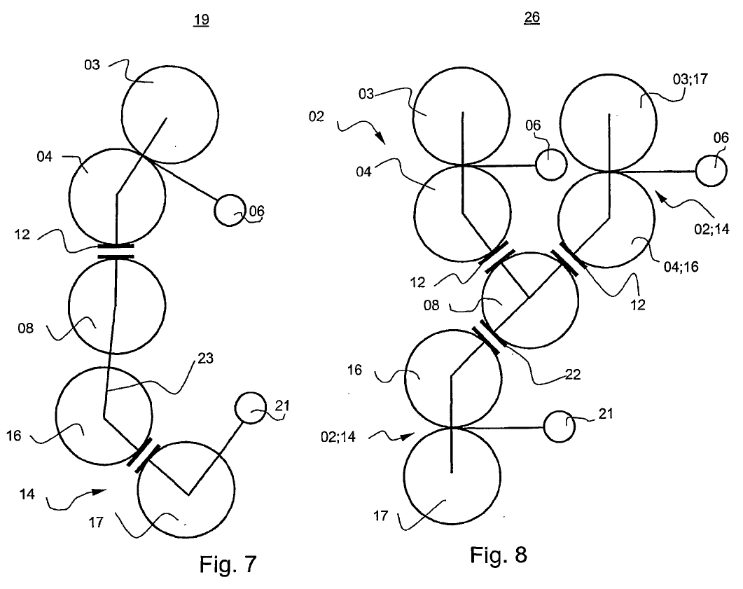

FIG. 7, a schematic representation of a lateral view of a seventh exemplary embodiment of a printing unit as five-cylinder printing unit,

FIG. 8, a schematic representation of a lateral view of an eighth exemplary embodiment of a printing unit as seven-cylinder printing unit,

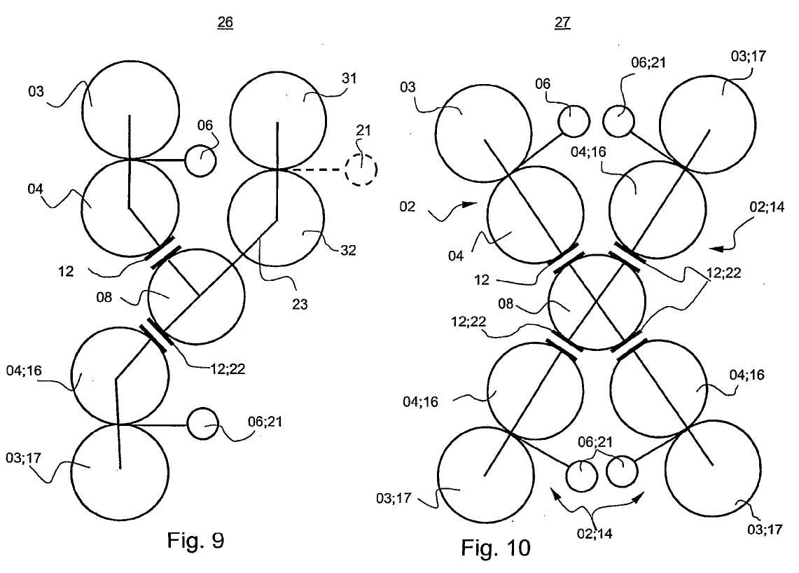

FIG. 9, a schematic representation of a lateral view of a ninth exemplary embodiment of a printing unit as seven-cylinder printing unit,

FIG. 10, a schematic representation of a lateral view of a tenth exemplary embodiment of a printing unit as nine-cylinder printing unit,

FIG. 11, a schematic representation of a lateral view of an eleventh exemplary embodiment of a printing unit as nine-cylinder printing unit,

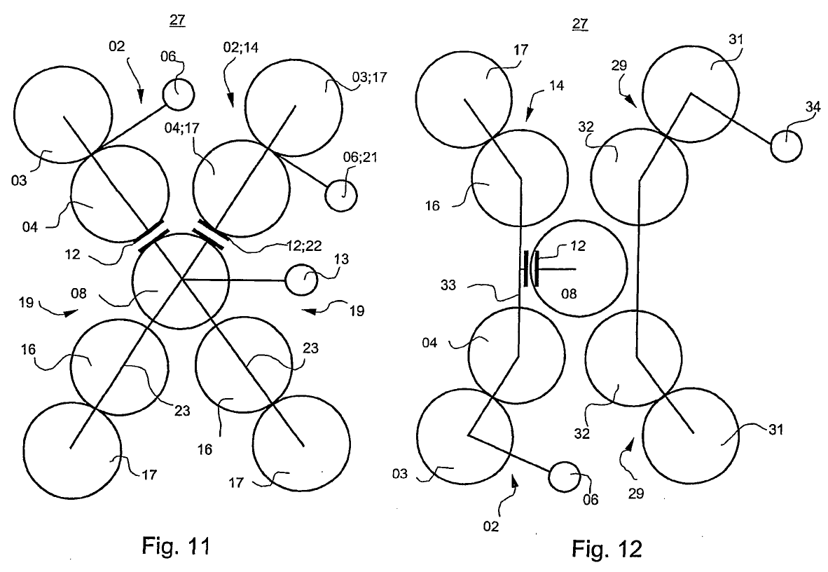

FIG. 12, a schematic representation of a lateral view of a twelfth exemplary embodiment of a printing unit as nine-cylinder printing unit,

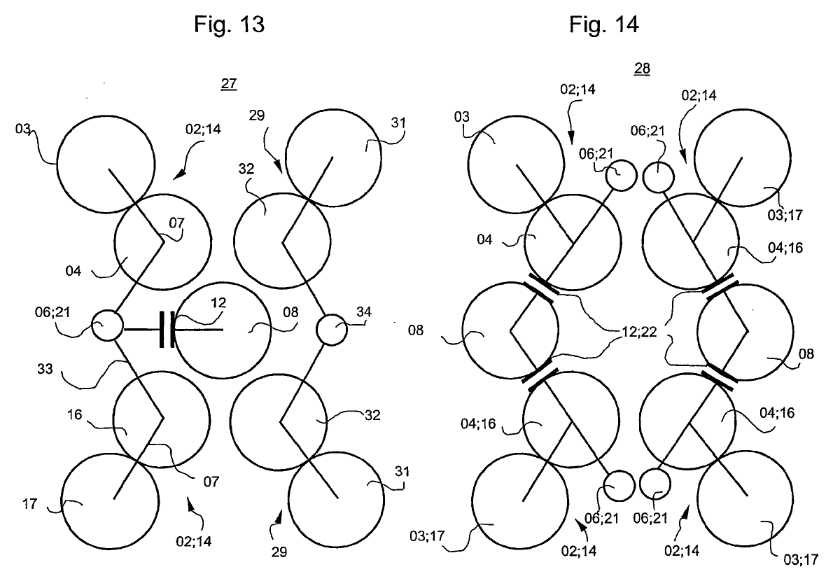

FIG. 13, a schematic representation of a lateral view of a thirteenth exemplary embodiment of a printing unit as nine-cylinder printing unit,

FIG. 14, a schematic representation of a lateral view of a fourteenth exemplary embodiment of a printing unit as ten-cylinder printing unit,

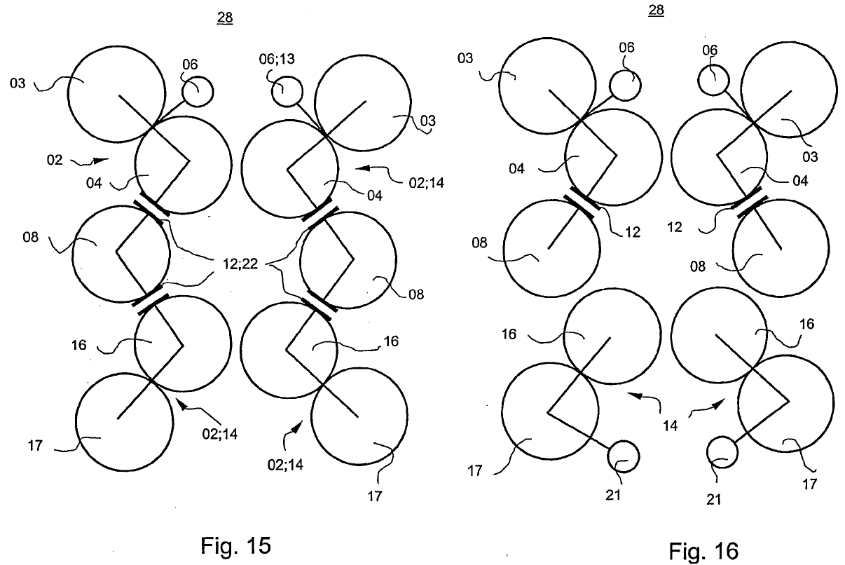

FIG. 15, a schematic representation of a lateral view of a fifteenth exemplary embodiment of a printing unit as ten-cylinder printing unit,

FIG. 16, a schematic representation of a lateral view of a sixteenth exemplary embodiment of a printing unit as ten-cylinder printing unit,

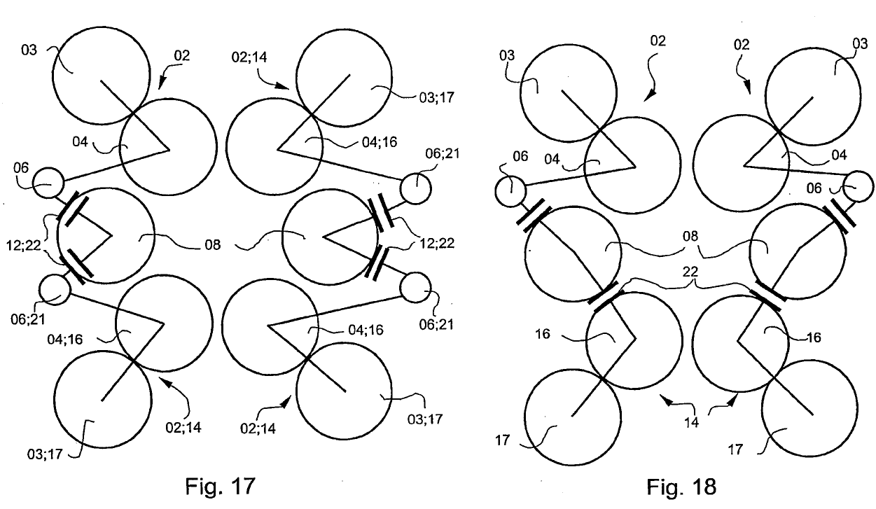

FIG. 17, a schematic representation of a lateral view of a seventeenth exemplary embodiment of a printing unit as ten-cylinder printing unit,

FIG. 18, a schematic representation of a lateral view of an eighteenth exemplary embodiment of a printing unit as ten-cylinder printing unit,

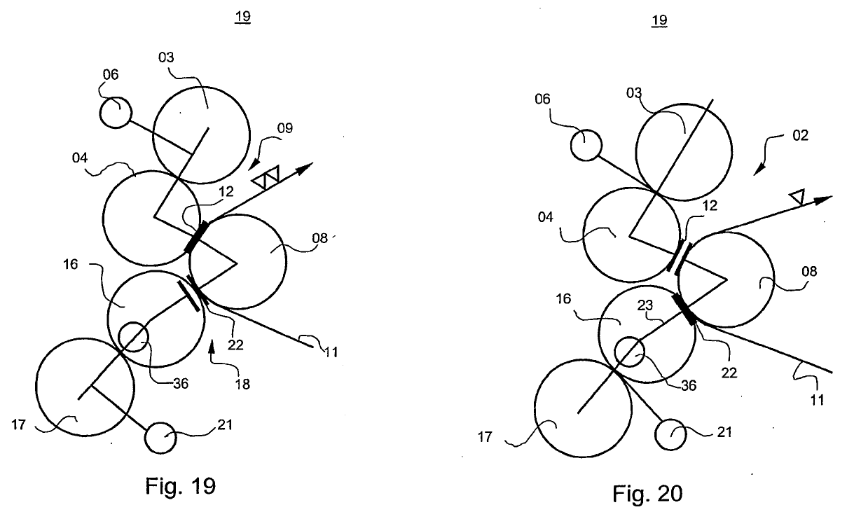

FIG. 19, a first operational state for operating a five-cylinder printing unit in accordance with the fourth exemplary embodiment,

FIG. 20, a second operational state for operating a five-cylinder printing unit in accordance with the fourth exemplary embodiment,

FIG. 21, a third operational state for operating a five-cylinder printing unit in accordance with the fourth exemplary embodiment,

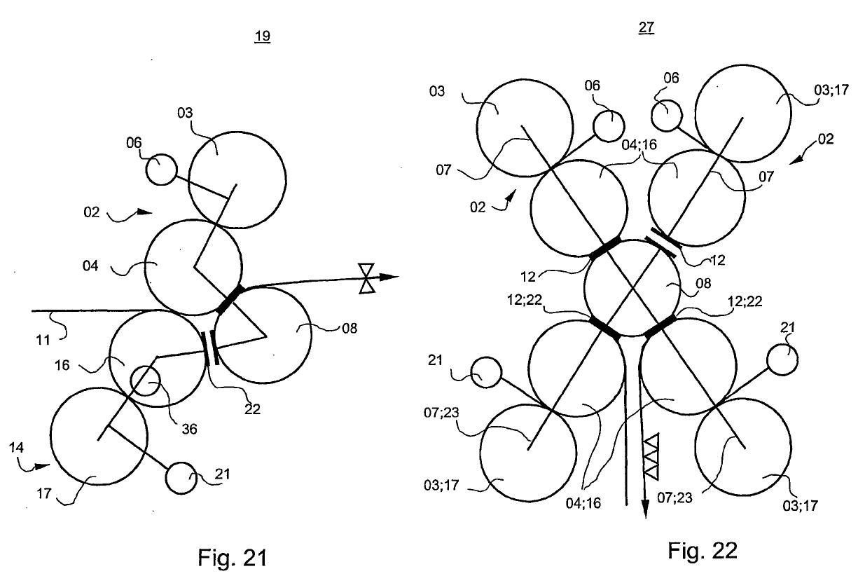

FIG. 22, a first operational state for operating a nine-cylinder printing unit in accordance with the tenth exemplary embodiment,

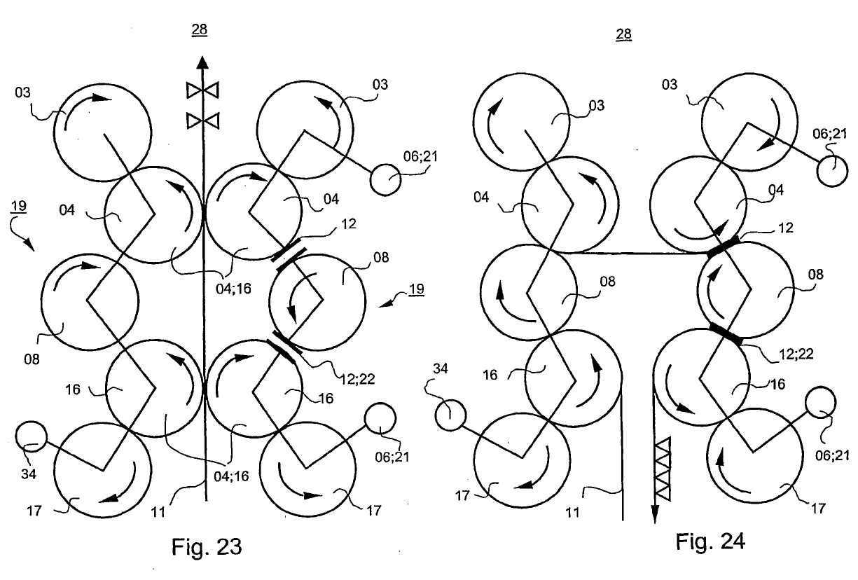

FIG. 23, a first operational state for operating a ten-cylinder printing unit,

FIG. 24, a second operational state for operating a ten-cylinder printing unit,

FIG. 23, a third operational state for operating a ten-cylinder printing unit.

A printing unit 01 of a printing press, in particular a web-fed rotary printing press, has a first pair 02 of cooperating cylinders 03, 04, for example a forme cylinder 03 and a first transfer cylinder 04 cooperating with it. For all exemplary embodiments, the pair 02 can also be fixedly or switchably mechanically connected with an ink and/or damping unit. The drive mechanism of the pair 02 is mechanically coupled and is provided by a common drive motor 06 during production. The first pair 02 and the drive motor 06 form a drive assembly 07. The drive motor 06 either drives the forme cylinder 03, which drives the transfer cylinder 4 via a mechanical coupling, for example a positive coupling by means of gear wheels, or vice versa. However, both cylinders 03, 04 can also be indirectly driven via a motor pinion or a wheel chain or via toothed belts and/or parallel from the direction of the drive motor 06. A drive assembly with fixed coupling and with or without motor is represented in the drawing by solid lines, which connect the axes of rotation of the respective cylinders, and possibly the drive motor. A releasable coupling, not represented in the drawings, can also be provided between the fixedly coupled pair 02 and the drive motor 06. No conclusions regarding the connected or disconnected state should be drawn from the schematic representations of FIGS. 1 to 18. In FIGS. 19 to 25 a transfer cylinder moved back from the cylinder 08 is at a distance from the cylinder 08. In FIGS. 1 to 18 a switchable coupling is generally represented by two lines, which vertically interrupt a drive assembly. In FIGS. 19 to 25 this double line indicates a released coupling, and a heavy single line an engaged coupling.

In what follows, a drive motor is understood to be a drive motor suitable for driving under production conditions, and not an auxiliary motor only suitable for auxiliary functions.

Together with a third cylinder 08, for example a satellite cylinder 08, the transfer cylinder 04 constitutes a print location 09, where the two cylinders 04 and 08 act together in a print-on position via a web 11 running between the cylinders 04 and 08, for example a web 11 of material to be imprinted or a paper web 11. In a print-on position, this third cylinder 08 serves as a backstop for the transfer cylinder 04. The drive mechanisms of the first pair 02 and the one of the third cylinder 08 are connected with each other by means of a switchable mechanical coupling 12, for example by means of a switchable connector 12. The switchable connector 12 can be a unidirectional connector or a continuous connector, a positive or a non-positive connector.

In a first three-cylinder group of exemplary embodiments (FIGS. 1 and 2), the third cylinder 08 is embodied as a satellite cylinder 08, in particular as a steel cylinder 08. Here, the printing unit 01 represents for example a three-cylinder color deck, or a part of a larger printing system. What was said above applies to the options of configuring the pair 02.

In a first exemplary embodiment (FIG. 1), the steel cylinder 08 is embodied without its own drive mechanism. The drive motor 06 of the first pair 02 drives the forme cylinder 03, which drives the transfer cylinder 04. In the subsequent FIGS. 2 to 17 the web 11 is not represented. The same reference numeral is also used again for recurring elements.

In the second exemplary embodiment (FIG. 2) the steel cylinder 08 is embodied with its own drive motor 13, which drives the steel cylinder 08 during production. The drive motor 06 here drives both cylinders 03, 04, for example by means of a train of wheels.

In a second group of exemplary embodiments (FIGS. 3 to 7) the third cylinder 08, which cooperates with the first pair 02, is embodied as a satellite cylinder, which cooperates with a second pair 14 consisting of a cylinder 16, for example a second transfer cylinder 16, and a cylinder 17, for example a second forme cylinder 17, and constitutes a second print location 18 between the satellite cylinder 08 and the second transfer cylinder 16. The satellite cylinder 08 can be coupled mechanically fixedly, or switchably, with the second pair 14, in particular the second transfer cylinder 16. However, it can also be embodied without being mechanically coupled with the second pair. Together with the two pairs 02, 14, the satellite cylinder 08 forms a five-cylinder printing unit 19.

The transfer cylinder 16 and the forme cylinder 17 of the second pair 14 can be coupled mechanically fixedly, or switchably, with each other. In special cases a mechanical coupling of the two cylinders 16, 17 can also be omitted. They can be driven by a drive motor 21 on one of the two cylinders 16, 17, or on both cylinders 16, 17. The driving by the drive motor 21 at the second pair 14 can also be omitted.

In the third exemplary embodiment (FIG. 3), the satellite cylinder 08 is connected via a second, switchable mechanical coupling 22, for example a connector 22, with the second pair 14. The drive and coupling configuration of the second pair 14, which is connected with the satellite cylinder 08, can be variously embodied, as explained above. In FIG. 3 the second pair 14 has a fixedly coupled drive assembly 23, but without its own drive motor. As indicated in dashed lines, however, the drive assembly 23 can also be switchably coupled with another drive assembly. The satellite cylinder 08 has the drive motor 13, for example.

The fourth exemplary embodiment (FIG. 4) represents a particularly advantageous variable five-cylinder printing unit 19 because it is particularly flexible. Again the satellite cylinder 08 is connected with the second pair 14 by means of the switchable mechanical coupling 22. The second pair 14 has the fixedly coupled drive assembly 23, wherein a drive motor 21 drives the second transfer cylinder 18, which drives the second forme cylinder 17. The driving of the second pair 14 can also take place at the second forme cylinder 17, or by means of a gear, not represented, by the drive assembly 23.

In contrast to FIG. 4, in the fifth exemplary embodiment (FIG. 5), the transfer cylinder 16 and the forme cylinder 17 are mechanically connected with each other by means of a third switchable mechanical coupling, for example a connector 24. In the example, the forme cylinder 17 has the drive motor 21. However, the drive motor 21 can also be arranged on the transfer cylinder 16, or on both cylinders 16, 17. Alternatively or additionally to this the satellite cylinder 08 can be embodied with the drive motor 13 (dashed lines).

In a sixth exemplary embodiment (FIG. 6), the satellite cylinder 08, together with the second pair 14, constitutes the fixed, non-switchable drive assembly 23. This drive assembly 23 can have one or several drive motors 21, 13. In the example, only the satellite cylinder 08 has the drive motor 13, which drives both cylinders 16, 17.

In a seventh exemplary embodiment (FIG. 7), the satellite cylinder 08, together with the transfer cylinder 16 of the second pair 14, constitutes the fixed, non-switchable drive assembly 23. In the example, the forme cylinder 17 has the drive motor 21, the drive assembly 23 consisting of the satellite cylinder 08 and the transfer cylinder 16 does not have its own drive motor. However, the drive assembly 23 can also have a drive motor 21 at the transfer cylinder 16, or a drive motor 13 at the satellite cylinder 08, or a drive motor 13, 21, which drives both cylinders 08, 16 via a gear. In that case the drive motor 21 at the forme cylinder 17 can possibly be omitted.

In an advantageous further development of the invention, the units consisting of the coupled pair 02 with its drive motor 06 and the connector 12 of the exemplary embodiments 1 to 7 constitute basic configurations, which can be standardized for a flexible configuration of larger cylinder groups, such as seven-cylinder printing units 26 in Y or lambda format, nine-cylinder 27 or ten-cylinder printing units 26 embodied as semi-satellite or satellite units.

FIG. 8 shows by means of the eighth exemplary embodiment a seven-cylinder printing unit 26, wherein a third pair 02, 14, consisting of transfer cylinders 04, 16 and forme cylinders 03, 17 provided with a drive motor 06 can be placed against the satellite cylinder 08 in accordance with the example in FIG. 4.

As represented in the ninth exemplary embodiment (FIG. 9), the third pair 29 can also form the fixed drive assembly 23 with the satellite cylinder 08. This drive assembly 23 can be embodied without or with its own drive motor 13, 12 (dashed lines).

The drive assembly 23 advantageously does not have its own drive motor, but instead is driven by one or both drive motors 06 via the connectors 12, 22.

In the tenth exemplary embodiment, FIG. 10 shows a symmetrical nine-cylinder printing unit 27 or satellite unit, with four mechanically fixedly coupled pairs 02, 14, and respectively one drive motor 06, 21, which are switchably coupled via four connectors 12, 22 with the satellite cylinder 08. However, depending on the requirements, it is also possible to make variations, wherein only one, two or three pairs 02 are coupled with the satellite cylinder 08 via a connector 12, 22.

FIG. 11 in the eleventh exemplary embodiment shows a nine-cylinder printing unit 27, wherein two pairs 02 arranged above the satellite cylinder 08 are switchably connected with the satellite cylinder 08. The two forme cylinders 17 and the transfer cylinder 16, arranged underneath, together with the satellite cylinder 08 constitute a drive assembly 23, which can be driven by means of a drive motor 13 arranged at the satellite cylinder. For example, two printing units 01 from the first two exemplary embodiments, as well as vertically arranged five-cylinder printing units 19 in accordance with the sixth exemplary embodiment, can be seen here. Depending on the requirements, for example with a horizontally guided web 11, a five-cylinder printing unit 19 can also be formed from two pairs 02, 14 located next to each other.

In a twelfth exemplary embodiment, FIG. 12, one of the two pairs 02 arranged underneath the satellite cylinder 08 of a nine-cylinder printing unit 27, or satellite unit, is driven by means of a drive motor 06 at the forme cylinder 03, which then drives the transfer cylinder 04. The transfer cylinder 04 drives, on the one hand, the transfer cylinder 16 of the fixedly coupled pair 14, but also the satellite cylinder 08 via a switchable connector 12. The pair 02 can be connected via the connector 12 with the satellite cylinder 08 and is fixedly mechanically coupled with the pair 14 located above it. Together with the drive motor 06, the two pairs 02, 14 constitute a drive assembly 33. In the example, two further pairs 29, consisting of respectively a cylinder 31, for example a forme cylinder 31, and a cylinder 32, for example a transfer cylinder 32, are fixedly coupled with each other and can be driven by a single further drive motor 34 arranged at the upper forme cylinder 31.

FIG. 13 shows the arrangement of the drive motor 06 for the pair 02 in such a way that again both pairs 02, 14, which are arranged above each other, can be driven by the one drive motor 06, 21 and are fixedly connected with each other. Together with the drive motor 06, 21, the two pairs 02, 14 constitute the drive assembly 33. The drive motor 06, 21 respectively drives the transfer cylinder 04, 16 of the fixedly coupled pairs 02, 14, which drives the associated forme cylinder 03, 17. The drive assembly 07 consisting of the forme cylinder 03, 07, transfer cylinder 04, 18 and the drive motor 06, 21 can be mechanically coupled via the connector 12 with the satellite cylinder 08. The two remaining pairs 29 are each mechanically coupled in pairs, wherein both pairs 29 can be driven by only the one drive motor 34 at the respective transfer cylinder 32, which drives the forme cylinder 31.

By means of a fourteenth exemplary embodiment, FIG. 14 shows a ten-cylinder printing unit 28, which has four pairs 02, or 14, which are driven in pairs at the transfer cylinder 04, or 16, by means of the drive motor 06, or 21. In the example, respectively two pairs 02, 14 arranged on top of each other are switchably mechanically connected with the cooperating satellite cylinder 08 via respective connectors 12, 22.

The two pairs 02, 16 from FIG. 14, which are respectively arranged underneath the associated satellite cylinder 08, however, can be embodied without their own drive motor, as represented in FIG. 15. But the two satellite cylinders 08 in FIG. 15 can also be mechanically coupled with each other and have a common drive motor 13 driving both satellite cylinders 08.

Also based on FIG. 14, in the sixteenth exemplary embodiment (FIG. 16), the pairs 14 arranged underneath the satellite cylinders 08 are not mechanically coupled, or cannot be coupled, with the associated satellite cylinder 08. There, the driving takes respectively place by means of a drive motor 21 at the forme cylinder 17.

The seventeenth exemplary embodiment (FIG. 17) represents the exemplary embodiment 14 in a representation which is modified for the embodiment. Each pair 02, 14 is driven by its own drive motor 06, 21, wherein each drive motor 06, 21 additionally selectively drives the satellite cylinder 08 cooperating with the respective pair 02, 14 via a switchable connector 12, 21.

In an eighteenth exemplary embodiment (FIG. 18), the two upper pairs 06 have a drive mechanism in accordance with the seventeenth exemplary embodiment. But the pairs 14 located below do not have their own drive motor, instead they can be coupled via the connectors 22 to the drive mechanism of the respectively associated satellite cylinder 08.

The configurations consisting of drive motors 06, 13, 21 and connectors 12, 22, 24, schematically represented in FIGS. 1 to 18, can be realized in different ways. For example, the driving can take place directly from the rotor to a journal of one of the cylinders 03, 04, 08, 16, 17 via shafts, via pinion gears with or without wheel chains, via toothed belts or also via friction gears. Also, the coupling-in or coupling-out of cylinders or cylinder groups can take place in that gear wheels, which are arranged, fixed against relative rotation, on the journals of the cylinders, can be displaced axially in respect to each other and in this way can be brought into or out of engagement. The last mentioned case should also be understood in the sense of the invention as a connector 12, 22, 24.

Each one of the drive configurations schematically represented in FIGS. 1 to 18 can be realized in different ways. For example, for switchably coupling two cylinders 03, 04, 08, 16, 17 with each other, for example the transfer cylinder 04 and the satellite cylinder 08, in a first case a first gear wheel can be seated, fixed against relative rotation, on a journal of the transfer cylinder 04, and a second gear wheel, which is in engagement with the former, can be seated, but rotatably, on a journal of the satellite cylinder 08. The second gear wheel on the journal of the satellite cylinder 08 can be selectively fixed in place by means of a connector 12, also seated, fixed against relative rotation, on a journal of the satellite cylinder 08. In a second case, the arrangement of the fixedly and rotatably seated gear wheels can take place in the reverse.

In the same way as by means of the schematic representations in FIGS. 14 and 17, or 15 and 18, respectively two options for coupling the pair 02, 14 to the satellite. In FIG. 14, or 15 the drive motor 06, 21 directly drives, for example via a pinion gear, a gear wheel arranged on the journal of the transfer cylinder 04, which drives a gear wheel of the satellite cylinder 08, wherein one of the gear wheels is embodied fixed against relative rotation, and the other gear wheel is rotatable, but selectively fixable in place. However, in an advantageous embodiment a rotatable gear wheel, which can be selectively fixed in place via the connector 12, 22, can be arranged on the journal of the satellite cylinder 08 and is driven via a pinion gear by the drive motor 06 and in turn drives a gear wheel arranged, fixed against relative rotation, on the transfer cylinder 04, 16. With the connector 12, 22 released, the drive motor 06, 21 drives the pair 02, 14, with the connector 12, 22 engaged, it drives the pair 02, 14 and the satellite cylinder 08 (FIG. 17 or 18).

A multitude of operational states can be realized by means of the described variations, which can be expanded by combination, only a few of which will be mentioned by way of example in what follows:

In the printing unit 01 with only one drive motor 06 arranged on the pair 02 and with the connector 12 released and in a print-off position, i.e. the transfer cylinder 04 is not placed against the satellite cylinder 08, rotation of the cylinders 03, 04 can take place without the satellite cylinder 08 being moved, and a possibly already drawn in web 11 along with the satellite cylinder 08.

If the satellite cylinder 08 also has a drive motor 13, with the connector 12 released a rotation of the satellite cylinder 08 independently of the pair 02, and therefore the continued conveying of the web 11, is possible without the pair 02 rotating along. A relative change of the angle of rotation position between the pair 02 and the satellite cylinder 08 is also possible. But with the connector 12 engaged, in the latter case and in the print-on position, dependability is provided by the full redundancy of the two drive motors 06 and 13, which run during production, a so-called “full back-up”. By reducing the drive output of the drive motors 06, 13 in steps, for example 60% to 40% of the required total output, an inexact drive because of possibly present play in the gear wheels or the gears, i.e. a possibly occurring tooth flank change, can also be prevented. Moreover, there is the option of a mechanical and/or electronic synchronization of the pair 02 and of the satellite cylinder 08.

For five-cylinder printing units 19 with five cylinders 03, 04, 08, 16, 17, further operational states result beyond the options already mentioned for the smaller printing units 01. Advantageous operational states are schematically represented in the following FIGS. 19 to 21 by means of the embodiment in accordance with FIG. 4.

In the present exemplary embodiment, at least one of the two transfer cylinders 04 or 16 from the fourth exemplary embodiment (FIG. 4) is seated in such a way that it can take up at least three positions: a print-on position against the satellite cylinder 08, a print-on position against the respectively other transfer cylinder 16 or 04, and a print-off position, in which the respective transfer cylinder 04 or 16 does not cooperate with any of the other two cylinders 16 or 04 and 08. A seating of one of the two transfer cylinders 04 or 16 is advantageous, wherein it can take up five positions, in which a print-off position at the satellite cylinder 08 and at the other transfer cylinders 16 or 04, as well as a further print-off position, for example for changing the rubber blanket, is added to the mentioned two printon positions. In this way, in the latter case it is possible to keep the pivot movements for the simple print-on or print-off position, without a simultaneous change of the print location, a reversing or a rubber blanket cylinder, considerably smaller. In the drawings, the respective transfer cylinders 04 or 16 are only in the first three mentioned positions for the sake of simplicity.

FIG. 19 shows the five-cylinder printing unit 19 configured corresponding to the variant in FIG. 4, wherein for example the transfer cylinder 16 can be brought into the at least three mentioned different positions, which is schematically indicated in FIGS. 19 to 21 by means of an eccentrically arranged bearing ring 36. The seating can be embodied as an eccentric two-ring or three ring seating, a double eccentric seating, as a linear guide or a bearing conducted on a curved track or in any other way. It should only be necessary to bring the respectively other transfer cylinder 04 into the two positions print-on (against the satellite cylinder 08) and print-off (away from the satellite cylinder 08). To make a clear distinction in the drawings, a cylinder 03, 04, 08, 16, 17 which can be placed in this way has not been separately indicated.

In FIG. 19, both transfer cylinders 04, 16 are placed against the satellite cylinder 08 and print on the web 11 at the two print locations 09, 18 doubly on one side of the web, for example in two colors (represented as one inverted triangle per imprint) in a so-called rubber-against-steel operation. In this case both connectors 12 and 22, or one of the two connectors 12, 22 can be closed, since all three cooperating cylinders 04, 08, 16 have the same direction of rotation. Also, as shown in FIG. 19, both drive motors 06, 21 can form a drive assembly 23 or 07, consisting of respectively two cylinders 16 and 17 and of three cylinders 03, 04, 08 (or vice versa), wherein the connector 12 is closed and the connector 22 open. Both drive motors 06 and 21 can also drive all five cylinders 03, 04, 08, 16, 17 if both connectors 12 and 22 are closed.

In FIG. 20, the second transfer cylinder 16 continues to be in the print-on position with the connector 22 closed. The transfer cylinder 04 is in the print-off position, the connector 22 is released. While the drive motor 21 together with the forme cylinder 17 and the transfer cylinder 16 forms the drive assembly 23, the forme cylinder 03 and the transfer cylinder 04 of the first pair 02 can be independently rotated, for example for a plate change, or stopped and accelerated again. This similarly applies in reverse in case of a plate change at the forme cylinder 17, when the connector 22 is opened and the connector 12 is closed. A reversal of the running direction of the web 11 is also possible by reversing the directions of rotation.

In FIG. 21 the transfer cylinder 16, which can be brought into three (or five) positions, is in the print-on position against the transfer cylinder 04, i.e. during a so-called rubber-against-rubber operation. In an advantageous manner the transfer cylinder 04 can furthermore be placed against the satellite cylinder 08. In this mode of operation the web 11 runs between the two transfer cylinders 04, 16 and is imprinted singly on both sides. The reversal of direction of the direction of rotation of the pair 14 required for this mode of operation demands the release of the connector 22 and therefore a drive of the second pair 14 by the drive motor 21 which is at least independent of the first pair 02. With only two drive motors 06, 21, a five-cylinder printing unit 19 configured in this way also meets the most varied requirements regarding the guidance of the web 11, the flying plate or rubber blanket change and the possibility of a reversal, even without the employment of elaborate individual drive motors.

For larger cylinder groups or units, such as seven-cylinder printing units 26, nine-cylinder printing units 27, and ten-cylinder printing units 28, corresponding functions and operational states can be integrated. A seven-cylinder printing unit 26 with three pairs 02, 14 in an embodiment in accordance with FIG. 9 with a total of only two drive motors can be flexibly employed, for example for 3/0, flying plate change or in the imprinting function during 2/0 printing. If one of the transfer cylinders 04, 16 is provided with a pivotable seating, for example the bearing ring 36, 2/1 printing and an imprinting function during 2/0 printing also be comes possible.

In what follows, the variety of the operating mode, simultaneously along with a small number of drive motors, will be explained by means of respective exemplary embodiments of a nine-cylinder printing unit 27 and a ten-cylinder printing unit 28.

The nine-cylinder printing unit 27 shown in FIG. 22 has an imprinter functionality. For example, one of the upper pairs 02 is in a pivoted-away position with the connector 12 open, while the second of the upper pairs 02 is placed into contact and performs the instantaneous printing, for example. The pivoted-away pair 02 can be refitted. In the course of a flying change of the imprint, the pivoted-away pair 02 is accelerated to the required circumferential speed by means of the drive motor 06 and can be coupled as required by means of the connector 12 with the satellite cylinder 08, while the pair 02 previously in contact is taken off the satellite cylinder 08 and is braked. In the example, the satellite cylinder 08 does not have its own drive motor and by means of the connectors 12, 22 is coupled into one or several drive assemblies 07, 23 in response to the required direction of rotation by means of the connectors 12, 22.

For example, the ten-cylinder printing unit 28 represented in FIG. 23 has an imprinted functionality, as represented in FIG. 22 for the nine-cylinder printing unit 27. In addition, it can be changed between a rubber-against-steel operation and a rubber-against-rubber operation if it is embodied with an appropriate pivotable bearing of one or several of the transfer cylinders 04, 16. In contrast to the pivoting of the transfer cylinders 04, 16 in a single five-cylinder printing unit 19, such as represented in FIGS. 19 to 22, here two transfer cylinders 04, 16 of two five-cylinder printing units 19, which are arranged almost symmetrically next to each other, are placed against each other for the rubber-against-rubber operation.

If, for example, the guidance of the web 11 is provided only from below and with 3/1 printing only in the direction of a predefined side, a configuration with a total of only three drive motors 06, 21, 34 and two connectors 12, 22 in accordance with FIGS. 23 to 25 is sufficient for making all mentioned functions in regard to imprinter functionality and reversing possible.

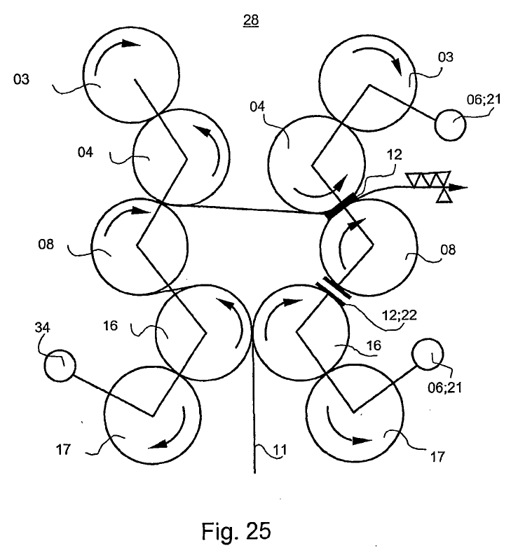

FIG. 23 shows an example of the paper guidance in 2/2 printing operation, FIG. 24 in 4/0 printing operation, and FIG. 25 in 3/1 printing operation. If increased flexibility regarding the guidance of the web 11 is required, a fall-back to the configuration in FIG. 14 can be made.

List of Reference Numerals

01 Printing unit

02 Pair, first

03 Cylinder, forme cylinder (02)

04 Cylinder, transfer cylinder (02)

05 -

06 Drive motor (02)

07 Drive assembly (02)

08 Cylinder, third, satellite cylinder, counter-pressure cylinder, steel cylinder

09 Print location

10 -

11 Web, web to be imprinted, paper web

12 Coupling, switchable, connector, first

13 Drive motor (08)

14 Pair, second

15 -

16 Cylinder, transfer cylinder, second

17 Cylinder, forme cylinder, second

18 Print location

19 Five-cylinder printing unit

20 -

21 Drive motor, (14)

22 Coupling, switchable, connector, second

23 Drive assembly (14)

24 Coupling, switchable, connector, third

25 -

26 Seven-cylinder printing unit

27 Nine-cylinder printing units

28 Ten-cylinder printing units

29 Pair

30 -

31 Cylinder, forme cylinder (24)

32 Cylinder, transfer cylinder (24)

33 Drive assembly

34 Drive motor (24)

35 -

36 Bearing ring

1. A printing unit, having a pair (02) comprised of a first forme cylinder (03) and a first transfer cylinder (04) cooperation with the forme cylinder (03), as well as a satellite cylinder (08) which, together with the transfer cylinder (04) forms a print location (09), wherein the drive mechanism of the forme cylinder (03) and the drive mechanism of the transfer cylinder (04) are fixedly coupled with each other and are driven during printing by a common first drive motor (06), which forms a drive assembly (07) with the first forme cylinder (03) and the first the transfer cylinder (04), characterized in that the drive assembly (07) of the pair (02) and the drive mechanism of the satellite cylinder (08) can be selectively switched and mechanically coupled with each other via a first connector (12).

2. The printing unit in accordance with claim 1, characterized in that the first drive motor (06) is arranged to drive the forme cylinder (03).

3. The printing unit in accordance with claim 1, characterized in that the first drive motor (06) is arranged to drive the transfer cylinder (03).

4. The printing unit in accordance with claim 1, characterized in that the first drive motor (06) is arranged to drive the transfer cylinder (04), the forme cylinder (03), or both cylinders (03, 04) via a gear.

5. The printing unit in accordance with claim 1, characterized in that the satellite cylinder (08) is embodied as a steel cylinder (08).

6. The printing unit in accordance with claim 1, characterized in that the satellite cylinder (08) has its own drive motor (13).

7. The printing unit in accordance with claim 1, characterized in that the satellite cylinder (08) cooperates with the second transfer cylinder (16), forming a second print location (18).

8. The printing unit in accordance with claim 7, characterized in that the second transfer cylinder (16) forms a second pair (14) together with a second forme cylinder (17).

9. The printing unit in accordance with claim 7, characterized in that the drive mechanisms of the satellite cylinder (08) and of the second transfer cylinder (16) are independent of each other.

10. The printing unit in accordance with claim 7, characterized in that the drive mechanisms of the satellite cylinder (08) and of the second transfer cylinder (16) are coupled with each other.

11. The printing unit in accordance with claim 10, characterized in that the drive mechanisms of the satellite cylinder (08) and of the second transfer cylinder (16) are switchably mechanically coupled with each other via a second connector (22).

12. The printing unit in accordance with claim 8, characterized in that the drive mechanisms of the second forme cylinder (17) and of the second transfer cylinder (16) are mechanically independent of each other.

13. The printing unit in accordance with claim 8, characterized in that the drive mechanisms of the second forme cylinder (17) and of the second transfer cylinder (16) are coupled with each other.

14. The printing unit in accordance with claim 13, characterized in that the drive mechanisms of the second forme cylinder (17) and that of the second transfer cylinder (16) are switchably mechanically coupled with each other via a third connector (24).

15. The printing unit in accordance with claim 8, characterized in that the second pair (14) does not have its own drive mechanism.

16. The printing unit in accordance with claim 8, characterized in that the second pair (14) can be driven by at least one drive motor (21) of its own.

17. The printing unit in accordance with claim 16, characterized in that the drive motor (21) is arranged at the second forme cylinder (17).

18. The printing unit in accordance with claim 16, characterized in that the drive motor (21) is arranged at the second transfer cylinder (16).

19. The printing unit in accordance with claim 8, characterized in that the pair (14) is coupled or can be coupled with a further drive assembly.

20. The printing unit in accordance with claim 1, characterized in that the printing unit (01) is a part of a seven-cylinder (26), nine-cylinder (27) or a ten-cylinder (28) printing unit.

22. A printing unit having at least two pairs (02, 14), each consisting of a forme cylinder (03, 17) and a transfer cylinder (04, 16) which, together with a satellite cylinder (08), form two print locations (09, 18), wherein the drive mechanisms of at least one of the pairs (02, 14) are fixedly coupled with each other and, together with a common drive motor (06, 21), constitute a drive assembly (07, 33), characterized in that the driving of the satellite cylinder (08), which is embodied without its own drive motor, can be selectively coupled with the drive assembly (07, 33) or can be released from the drive assembly (07, 33) of the at least one pair (02, 16).

23. The printing unit in accordance with claim 22, characterized in that the two pairs (02, 14) constitute a drive assembly (33) which can be driven by a common drive motor (06, 21).

24. The printing unit in accordance with claim 22, characterized in that the two pairs (02, 14) each form a fixed drive assembly (07), which can be driven by its own drive motor (06) and to which the drive mechanism of the satellite cylinder (08) can be selective coupled.

25. A printing unit having four pairs (02, 14, 29), each consisting of a forme cylinder (03, 17, 31) and a transfer cylinder (04, 16, 32), each cooperating with the forme cylinder (03, 17, 31), as well as at least one satellite cylinder (08) which, together with the transfer cylinders (04, 16, 32), forms a print location (09), wherein the drive mechanisms of the forme cylinder (03) and the transfer cylinder (04) of at least one of the pairs (02) are fixedly mechanically coupled with each other and are driven during the printing process by a common first drive motor (06) which, together with the coupled pair (02), forms a drive assembly (07), characterized in that the drive assembly (07) of the coupled pair (02) and drive mechanism of the satellite cylinder (08) can be selectively switchably mechanically connected with each other via a connector (12).

26. A printing unit having four pairs (02, 14, 29), each consisting of a forme cylinder (03, 17, 31) and a transfer cylinder (04, 16, 32), each cooperating with the forme cylinder (03, 17, 31), as well as at least one satellite cylinder (08) which, together with the transfer cylinders (04, 16, 32), forms a print location (09), wherein the respective drive mechanism of the forme cylinders (03, 17) and the drive mechanism of the transfer cylinder (04, 16) of two pairs (02, 14), which are arranged next to each other in respect to a circumference of the associated satellite cylinder, are fixedly mechanically coupled with each other, characterized in that during the printing process the two coupled pairs (02, 14) are driven by a common drive motor (06), together with which they form a drive assembly (33), and that this drive assembly (33) can be switchably mechanically coupled with the associated satellite cylinder (08) via a connector (12).

27. A printing unit having four pairs (02, 14, 29), each consisting of a forme cylinder (03, 17, 31) and a transfer cylinder (04, 16, 32), each cooperating with the forme cylinder (03, 17, 31), as well as at least one satellite cylinder (08) which, together with the transfer cylinders (04, 16, 32), forms a print location (09), wherein the drive mechanisms of the forme cylinder (03) and the transfer cylinder (04) of at least two of the pairs (02, 14) are fixedly mechanically coupled with each other and are each driven during the printing process by a drive motor (06) which, together with the coupled pair (02), forms a drive assembly (07), characterized in that the respective drive assembly (07) of the coupled pairs (02) and the drive mechanism of the associated satellite cylinder (08) can be selectively switchably mechanically coupled with each other via a connector (12).

28. The printing unit in accordance with one of claims 25, 26 or 27, characterized in that the printing unit has two satellite cylinders (08).

29. The printing unit is accordance with claim 27 and 28, characterized in that the respectively coupled pairs (02) can be mechanically coupled with a common satellite cylinder (08).

30. The printing unit is accordance with claims 27 and 28, characterized in that the respectively coupled pairs (02) can be mechanically coupled with different satellite cylinders (08).

31. The printing unit in accordance with one of claims 25, 26 or 27, characterized in that the remaining pairs (14) are each driven by a common drive motor (21).

32. The printing unit is accordance with one of claims 25, 26 or 27, characterized in that at least two of the remaining pairs (29) are driven by a common drive motor (34).
